(19) United States
(12) Patent Application Publication
(10) Pub. No.: US 2018/0152780 A1
(43) Pub. Date: May 31, 2018

(54) INTERACTIVE STEREO HEADPHONES WITH VIRTUAL CONTROLS AND INTEGRATED MEMORY

(71) Applicants: Matthew Hawkes, South Jordan, UT (US); Spencer Lifferth, Layton, UT (US); Denarius Motes, Woodland Hills, CA (US); David Tucker, Salt Lake City, UT (US)

(72) Inventors: Matthew Hawkes, South Jordan, UT (US); Spencer Lifferth, Layton, UT (US); Denarius Motes, Woodland Hills, CA (US); David Tucker, Salt Lake City, UT (US)

(21) Appl. No.: 15/246,521

(22) Filed: Aug. 24, 2016

Related U.S. Application Data
(60) Provisional application No. 62/209,265, filed on Aug. 24, 2015.

(51) Int. Cl. H04R 1/10; G06F 3/16; G06F 3/0488; H04N 5/225

(52) U.S. Cl. CPC H04R 1/1041; H04R 1/1008; H04R 1/105; G06F 3/165; H04R 2420/09; H04R 1/1066; H04N 5/225; H04R 2420/07; G06F 3/04883

(57) ABSTRACT

Headphones are provided having vitual controls displayed on a circular touch screen and integrated memory, the headphones comprising a arcuate headband, two inner bodies for adjusting a size of the headphones, two earpieces, a receiver, a transmitter, and computer-readable memory. The headphones are adapted to interact with a wearer through the virtual controls, permitting a wearer to assign playback settings, and to accept wireless input from a remote data processing (DPD) device.

### CROSS-REFERENCE TO OTHER APPLICATIONS

This patent application claims priority to, and incorporates, U.S. provisional patent application No. 62/209,265 entitled “Multi-Function Headphones” filed on Aug. 24, 2015 for Matthew Hawkes.

### BACKGROUND OF THE INVENTION

### Field of the Invention

This invention relates to headphones, and more particularly relates to interactive stereo headphones with integrated memory and virtual controls.

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

By way of educational background, headphones are well-known in the art, and generally include a pair of small loudspeakers that are designed to be held in place close to a user's ears. Headphones typically either have wires for connection to a signal source such as an audio amplifier, radio, CD player, portable media player or mobile phone, or have a wireless receiver. Typically, headphones in the art emit sound that is perceptible by humans at frequencies from about 20 Hz to 20,000 Hz.

Headphones heretofore devised and utilized are known to consist of an adjustable headband and a pair of earpieces coupled to the headband. Each of the earpieces has an open inner face which defines a cavity in the respective earpiece. Each earpiece may also have a generally circular shaped fabric covered shield covering the open inner face of the respective earpiece. The inner face of each of the earpieces has a center extent extending into the cavity of the respective earpiece. The center extent has a plurality of side faces each having at least one speaker mounted thereto.

Traditional headphones including cumbersome wires have not traditionally included separate power supplies. Traditional headphones have not typically included amplifiers, and serve only to emit sounds through integrated speakers rather than to interact with a user or provide playback functionality. Audio recordings and playback of audio recording is traditionally handled by a data processing device (DPD) in logical connectivity with the headphones, while the headphones themselves lack this ability.

In these respects, interactive headphones according to the present invention substantially depart from the conventional concepts and designs of the prior art, and in so doing provide an apparatus for enhancing a wearer's listening experience by providing integrated playback function, integrated memory, and integrated playback controls.

In view of the foregoing, it is clear that these traditional headphones are not optimal and leave room for more optimal approaches. There is a need in the art for interactive headphones with integrated controls and memory. It is therefore desirable that such an apparatus and system be provided.

### SUMMARY OF THE INVENTION

From the foregoing discussion, it should be apparent that a need exists for a interactive headphones with virtual controls and integrated memory. Beneficially, such an apparatus would overcome many of the difficulties with prior art by providing a single apparatus with integrated power supply, audio files and playback functionality.

The present invention has been developed in response to the present state of the art, and in particular, in response to the safety problems and needs in the art that have not yet been fully solved by currently available aparati. Accordingly, the present invention has been developed to provide interactive headphones for storing computer-readable audio files and generating sound therefrom, the headphones comprising: an arcuate headband adapted for contouring a wearer's head, the arcuate headband defining two hollow recesses for receiving a male end of an inner body; two inner bodies affixed to the arcuate headband, each of the inner bodies adapted to slide longitudinally within a hollow recess; a circular touch screen recessed into an exterior outer surface of one of the inner bodies; a battery; an amplifier; a control module comprising a processor, the control module configured to display virtual controls in the form of a virtual image of a record on the touch display, the virtual manipulable to start, stop, fastforward and rewind playback of an audio file in computer readable memory; computer readable memory; and two earpieces affixed to an inner body for engaging the ear of the wearer, the earpieces comprising: a concave ear cup with an open inner end defining a first hollow recess for receiving a speaker; a speaker; and a detachable flexible ear cup for annularly circumscribing the ear cup.

The headphones may further comprise a plurality of depressible buttons for raising and lower a volume of sound emanating from the speakers. In other embodiments, the control module may be configurable by a user to set a maximum volume decibel level for each respective speaker, the maxium volume deciblel level stored in the computer readable memory.

The control module may limit sounds emiting from each speaker to a volume less than the maxium volume decibel level exclusively associated with said speaker. The control module may be configurable by a user to set a playback percentage for each speaker, the playback percentage exclusively associated with a speaker, the playback percentage stored in the computer-readable memory.

The control module may emit a percentage of volume corresponding to the playback percentage through a speaker exclusively associated with the playback percentage.

In various embodiment, the touch screen is 2.5 inches in diameter. The headphones may also comprise a depressible power button disposed beneath the touch screen.

The touch screen may be adapted to fast forward playback of an audio file in computer-readable memory in response to sensing a wearer's engagement of the touch screen with a finger in a clockwise direction.

The touch screen may further be adapted to rewind playback of an audio file in computer-readable memory in response to sensing a wearer's engagement of the touch screen with a finger in a counterclockwise direction.

In some embodiments, the touch screen is adapted to stop forward playback of an audio file in computer-readable memory in response to sensing a wearer's taping the touch screen with a finger.

The touch screen may be adapted to return to a main menu in response to sensing a wearer's taping the touch screen with two fingers. The touch screen may alternatively be adapted to return to a main menu in response to sensing a wearer's taping the touch screen with two fingers.

In still futher embodiments, the headphones further comprise a wireless receiver, the headphones adapted to receive wireless input via the wireless receiver transmitted from a tablet computer, the wireless input changing playback settings on the headphones.

The headphones may be in wireless connectivity with the tablet computer using BlueTooth® technology.

The headphones may be in wireless connectivity with the tablet computer using BlueTooth® technology. An output of the speakers may limited to 85 decibels or a predetermined volume threshold. The touch screen may be configured by the wearer to display a logo of an athletic team.

In some embodiments, an audio file being played back on the headphones is transmitted wireless to a second pair of headphones inconnected with the headphones via a LAN. The headphones may additionally or alternatively comprise a forward-facing camera.

Interactive headphones for storing computer-readable audio files and generating sound therefrom are also provided, the headphones comprising: an arcuate headband adapted for contouring a wearer's head, the arcuate headband defining two hollow recesses for receiving a male end of an inner body; two inner bodies affixed to the arcuate headband, each of the inner bodies adapted to slide longitudinally within a hollow recess; a circular touch screen recessed into an exterior outer surface of one of the inner bodies, the circular touch screen 2.5 inches in diameter; a battery; a computer-readable memory; a computer program product operable to impart function to the headphones, the computer program product operable to display virtual controls in the form of a virtual image of a record on the touch display, the virtual manipulable to start, stop, fastforward and rewind playback of an audio file in computer readable memory; computer readable memory; and two detachable earpieces affixed to an inner body for engaging the ear of the wearer, the earpieces comprising: a concave ear cup with an open inner end defining a first hollow recess for receiving a speaker; a speaker; and a detachable flexible ear cup for annularly circumscribing the ear cup.

The touch screen may be adapted to return to a main menu in response to sensing a wearer's taping the touch screen with two fingers. The headphones may further comprise a detachable memory card. The headpones alternatively further comprise a wireless receiver.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a forward perspective view of interactive headphones with virtual controls and integrated memory in accordance with the present invention;

FIG. 2A is a side perspective view of interactive headphones with virtual controls and integrated memory in accordance with the present invention;

FIG. 2B is a side perspective view of the touch screen of interactive headphones with virtual controls and integrated memory in accordance with the present invention;

FIG. 2C is a side perspective view of the touch screen of interactive headphones with virtual controls and integrated memory in accordance with the present invention;

FIG. 2D is a side perspective view of the touch screen of interactive headphones with virtual controls and integrated memory in accordance with the present invention;

FIG. 2E is a side perspective view of the touch screen of interactive headphones with virtual controls and integrated memory in accordance with the present invention;

FIG. 2F is a side perspective view of the touch screen of interactive headphones with virtual controls and integrated memory in accordance with the present invention;

FIG. 2G is a side perspective view of the touch screen of interactive headphones with virtual controls and integrated memory in accordance with the present invention;

FIG. 2H is a side perspective view of the touch screen of interactive headphones with virtual controls and integrated memory in accordance with the present invention;

FIG. 2I is a side perspective view of the touch screen of interactive headphones with virtual controls and integrated memory in accordance with the present invention;

FIG. 3 is a forward perspective view of a headphone of interactive headphones with virtual controls and integrated memory in accordance with the present invention;

FIG. 4 is a side perspective view of a headphone of interactive headphones with virtual controls and integrated memory in accordance with the present invention;

FIG. 5 is an elevated front-side perspective view of a headphone of interactive headphones with virtual controls and integrated memory in accordance with the present invention;

FIG. 6 is a top perspective view of interactive headphones with virtual controls and integrated memory in accordance with the present invention;

FIG. 7 is an elevated front-side perspective view of interactive headphones with virtual controls and integrated memory in accordance with the present invention;

FIG. 8 is an elevated front-side perspective view of a headband of interactive headphones with virtual controls and integrated memory in accordance with the present invention;

FIG. 9A is a front-side perspective view of a main inner body of interactive headphones with virtual controls and integrated memory in accordance with the present invention;

FIG. 9B is a side perspective view of a main inner body of interactive headphones with virtual controls and integrated memory in accordance with the present invention;

FIG. 10 is a front-side perspective view of a main inner body cover of interactive headphones with virtual controls and integrated memory in accordance with the present invention;

FIG. 11 is a front-side perspective view of a middle balance ring of interactive headphones with virtual controls and integrated memory in accordance with the present invention;

FIG. 12 is a front-side perspective view of a concave housing of interactive headphones with virtual controls and integrated memory in accordance with the present invention;

FIG. 13 is a front-side perspective view of an ear cup plastic cover of interactive headphones with virtual controls and integrated memory in accordance with the present invention;

FIG. 14 is a front-side perspective view of an ear cup of interactive headphones with virtual controls and integrated memory in accordance with the present invention;

FIG. 15 is a front-side perspective view of a subassembly of interactive headphones with virtual controls and integrated memory in accordance with the present invention;

FIG. 16 is a flow chart of the steps of a method for controlling interactive headphones with virtual controls and integrated memory in accordance with the present invention; and

FIG. 17 is a block diagram of the modules of a system for controlling interactive headphones with virtual controls and integrated memory in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to convey a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

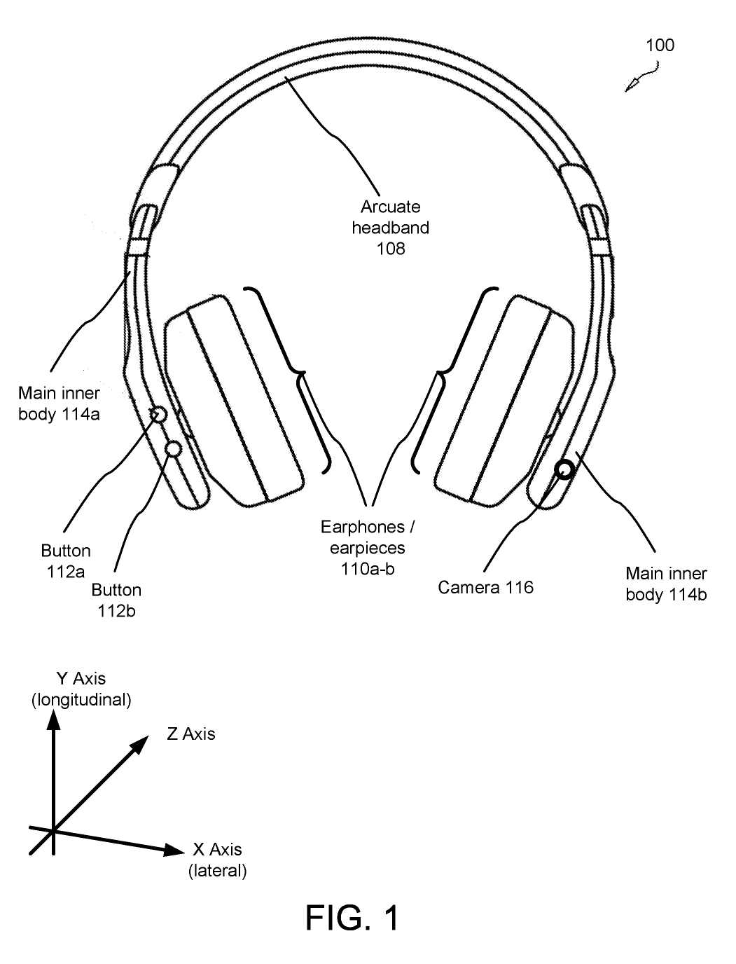

FIG. 1 is a forward perspective view of interactive headphones 100 with virtual controls and integrated memory in accordance with the present invention. The headphones 100 comprise an arcuate headband 108, a main inner body 114a, a main inner body 114b, an earpiece 110a, an earpiece 110b, and two depressible buttons 112a-b.

The arcuate headband 108 comprises a tubular bowed component adapted to conform to the exterior top surface of a wearer's skull. In various embodimetns, the arcuate headband is flexible facilitating additional adjustment.

The headband 108 defines, in the shown embodiment, two hollow interior recesses in which a main inner body 114 travels. The headband 108 has two open ends for permitting the main inner bodies 114 to be inserted and adjusted slidably related to the headband 108. These interior recesses receive a male end of the main inner bodies 114.

In various embodiments, the arcuate headband 108 and the main inner bodies 114 are formed from polymeric, organic, or metallic materials, including steel, nylon and leather. The arcuate headband 108 may be formed as a single integrated piece, or may comprise a plurality of layered components which snap or are otherwise affixed together using meanings known to those of skill in the art.

Likewise, the main inner bodies 114 may also be formed as a single integrated piece, or be formed from a plurality of components, usually mold injected, which are affixed together. The main inner bodies 114 protrude downwardly on the longitudinal axis and provide affixation points for the earpieces 110.

The depressible buttons 112a-b may comprise volume controls which are adapted to raise or lower volume of sound emitting or emanating from speakers within the earpieces 110a-b. In various embodiments, the depressible buttons 112 raise or lower resistance to electrical current flowing to the speakers.

The headphones 100 may comprise a camera 116 as shown. In the shown embodiment, the camera is forward facing enabling a wearer to film video of scenes in front of the headphones 100 and record these video files in computer readable memory. In various embodiments, the headphones 100 may be set or configured by the wearer to transmit these video files to a remote data processing device (DPD) including a second pair of headphones 100 and/or a tablet computer, smart phone, desktop, server and the like.

In various embodiments, the camera 116 is housed with an aperture or recess on the exterior of the main inner body 114a or main inner body 114b. In other embodiments, the headphones 100 comprise a plurality of cameras adapted for use in different lighting and environmental conditions.

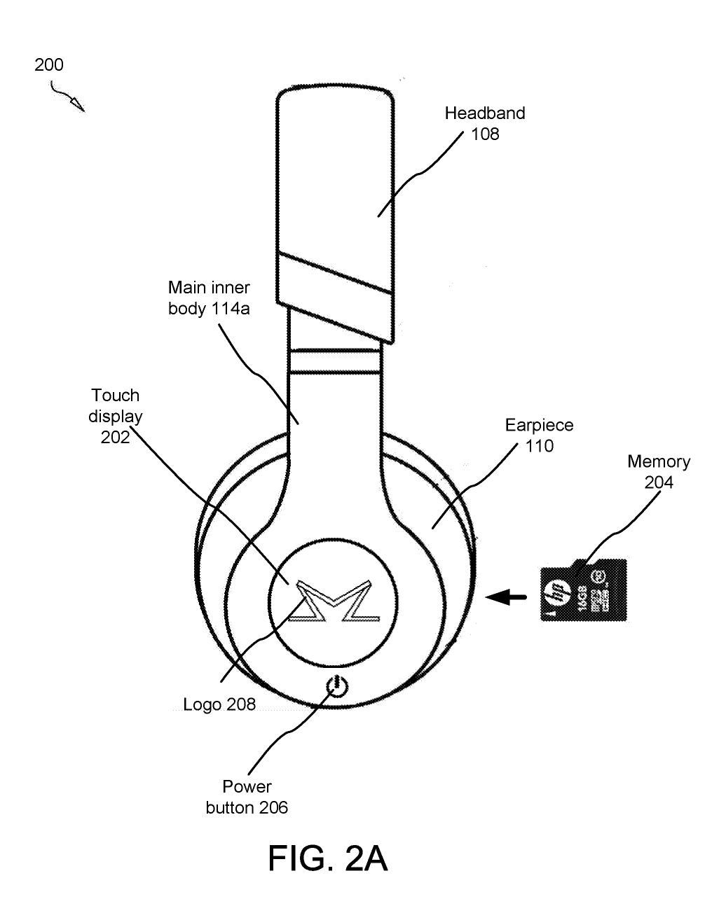

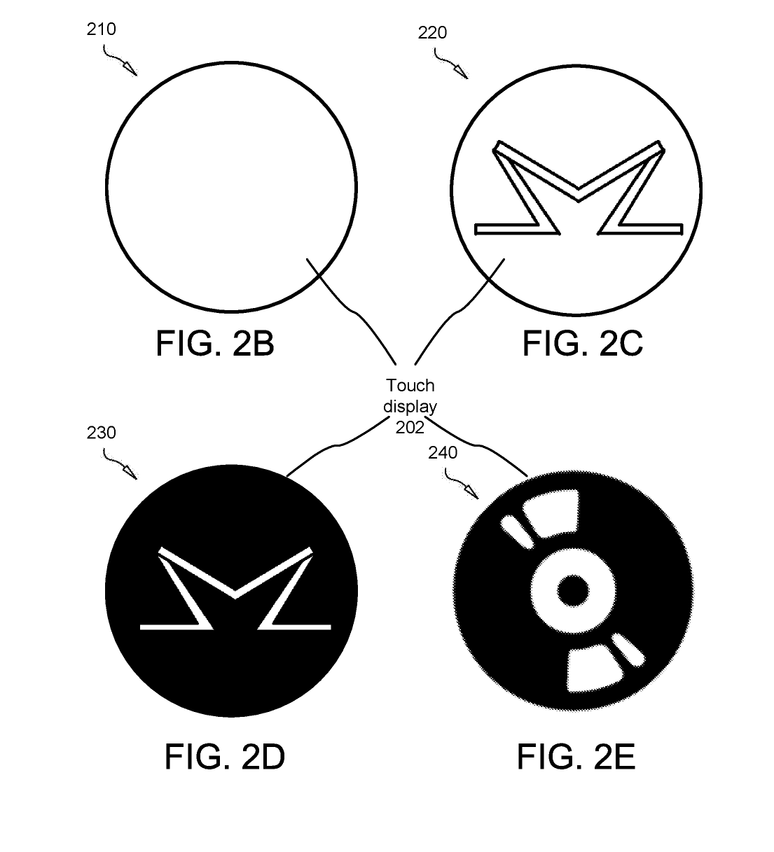

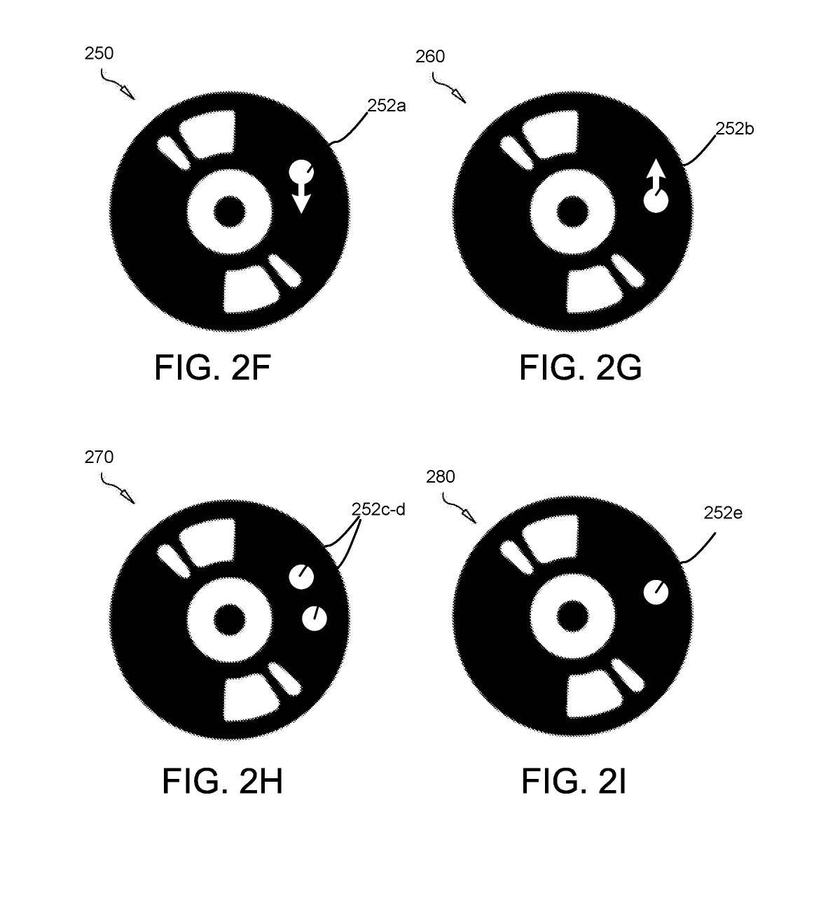

FIG. 2A is a side perspective view of interactive headphones 200 with virtual controls and integrated memory in accordance with the present invention. The headphones 200 comrpise a headband 108, an earpiece 110, a touch display 202, a detachable memory 204, and a power button 206.

The headband 108 and main inner body 114 are substantially described above. The memory 204 comprises, in the shown embodiment, a memory card, and is well-known to those of skill in the art. The memory 204 may be insertable and removable from a positioning slot defined by the main inner body 114. In various embodiments, the audio recordings are stored in the memory 204 for playback by the headphones 200. The audio recordings may be in MP3, WAV, or other formats known to those of skill in the art. In various embodiments, other types of computer readable media are stored in the memory 204, including video and images in formats known to those of skill in the art, including JPG, SNP, and MP4.

The touch screen 202 is circular in the shown embodiment to facilitate provision of circular virtual controls and to increase resemblance of the touch display 202 to a vinyl record when a vinyl record is displayed on the touch display 202. In the shown embodiment, a manufacturer logo is presently displayed on the touch display 202.

A depressible power button 206 adapted to activate, power on, and boot up the headphones 200 is disposed beneath the touch screen 202 on the main inner body 114.

FIG. 2B is a side perspective view of the touch screen of interactive headphones with virtual controls and integrated memory in accordance with the present invention. In FIG. 2B, the touch display is at rest in the off, or powered off, position. The display is blank.

FIG. 2C is a side perspective view of the touch screen of interactive headphones with virtual controls and integrated memory in accordance with the present invention. When the headphones 200 are powered on using the depressible power button 206, a manufacturer's logo 208 is displayed while the headphones 200 are booting up.

In additional embodiments, a wearer may select from a main menu displayed on the touch display 202 after booting up a media file in computer readable member 204 for displaying on the touch display 202. In various embodiments, this media file is an image comprising a logo, colors, or a trademark of another party.

These logos, colors or trademarks may displayed on the headphones 200 as a sign of wearer support for a group, cause, or athletic event. Examples include sporting events at which wearers of the headphones 200 wish to display an image of the logo or mascot of the athletic team the wearer is supporting. In other embodiments, the media file comprises video which is displayed and repeated on the touch display 202.

FIG. 2D is a side perspective view of the touch screen of interactive headphones with virtual controls and integrated memory in accordance with the present invention. The manufacturer's logo 208 may be inverted during boot up, or in low light conditions.

FIG. 2E is a side perspective view of the touch screen of interactive headphones with virtual controls and integrated memory in accordance with the present invention. As shown, the touch display 202 is configured to display a virtual record.

This virtual record comprises the virtual controls governing playback in some embodiments of the present invention.

FIG. 2F-2I all illustrate a side perspective view of the touch screen of interactive headphones with virtual controls and integrated memory in accordance with the present invention. In each of these variations, an environmental touch point 252 is graphicaly displayed.

The touch display 202 is adapted to sense engagement of a wearer's finger and movement of the finger in a clockwise direction as indicated by the arrow. The headphones 200 are adapted to respond to this movement by fastforwarding the playback of an audio file being played from computer-readable memory 204.

The touch display 202 may be additionally or alternatively adapted to sense engagement of a wearer's finger and movement of the finger in a counterclockwise direction. The headphones 200 are adapted to respond to this movement by rewinding the playback of an audio file being played from computer-readable memory 204.

The touch display 202 may be additionally or alternatively adapted to sense taping of two of the wearer's fingers. The headphones 200 are adapted to respond to this engagement by returning the touch display 202 to a main menu form which the wearer can adjust playback settings, including volume, bass, and maximum volume decibel levels exclusively associated with each speaker in the headphones 200 or alternatively with each earpiece 110.

The touch display 202 may be additionally or alternatively adapted to sense a tap or taping of a wearer's finger. The headphones 200 are adapted to respond to this movement by stopping or starting the playback of an audio file being played from computer-readable memory 204.

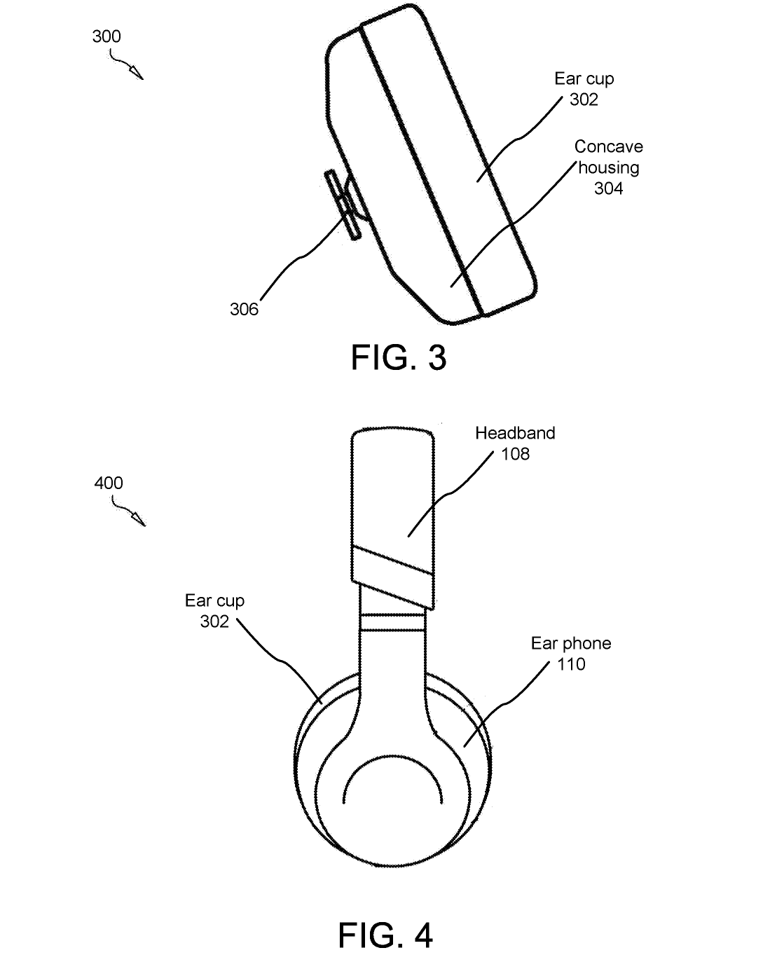

FIG. 3 is a forward perspective view of an earpiece 300 of interactive headphones with virtual controls and integrated memory in accordance with the present invention. The earpiece 300 comprises an ear cup 302 and a concave housing 304.

In various embodiments, the ear cup 302 comprises a foam or otherwise flexible annular ring or flange circumscribing an open end of the concave housing 304 for engaging and covering a wearer's ears.

The concave housing 306 may be formed from polymeric, metallic, or metal alloys. The concave housing 306 defines a hollow interior recess for receiving and housing a number of components, including a speaker, a middle balance ring, an aluminum ear cup, an ear cup plastic liner, and an ear cup plastic cover.

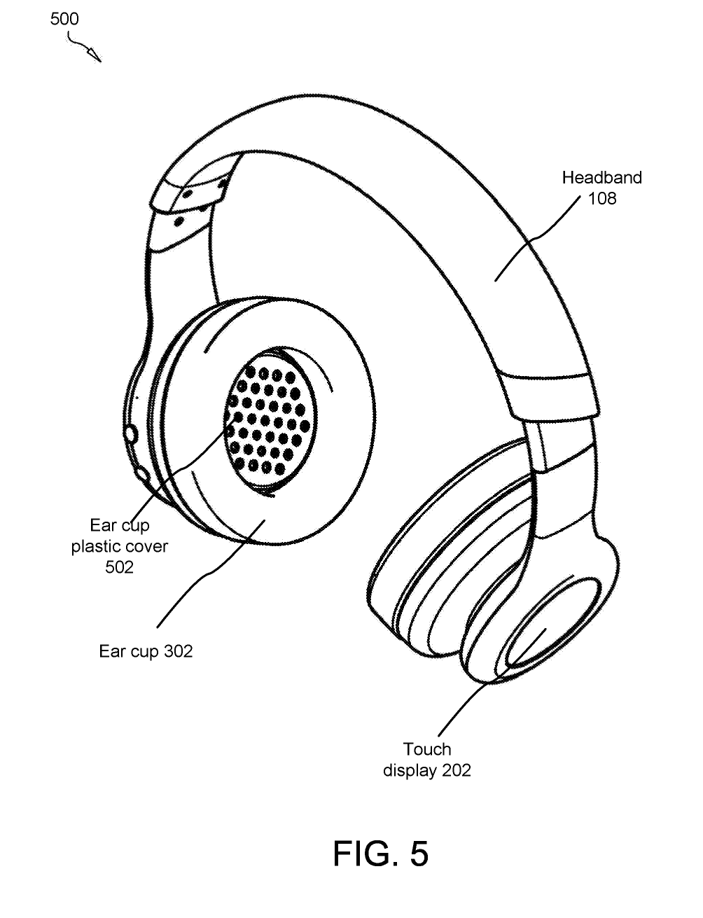

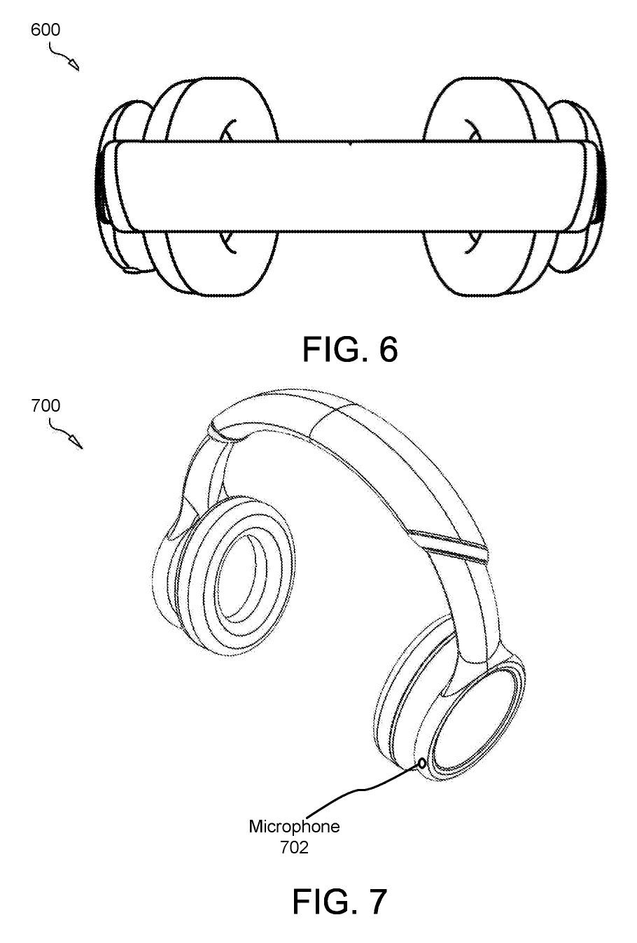

FIG. 5 is an elevated front-side perspective view of a headphone of interactive headphones 500 with virtual controls and integrated memory in accordance with the present invention. The headphones 500 comprise an ear cup plastic cover 502 with a plurality of apertures for facilitating the emanance of sound from an internal speaker. The touch display 202 is affixed to an exterior surface of headphones 500.

FIG. 7 is an elevated front-side perspective view of interactive headphones with virtual controls and integrated memory 700 in accordance with the present invention.

The headphones 700 comprise a microphone 702 in the shown embodiment. A microphone is well-known to those of skill in the art.

In the shown embodiment, the microphone 702 is used to convert sound waves to a digital input which is used by a translation module comprises a computer program product for translating spoken words in once native language into another played through the speakers.

In various other embodiments, the headphones 200 comprise a plurality of microphones 702 for collecting sound surrounding the headphones 200. This ambient sound may be amplified by the headphones 200 and replayed via the speakers for the wearer. In this function, the headphones are used as hearing aids for the wearer. In other embodiments, the microphones 702 are bunched on a forward surface of the headphones 200 to collect sound more effectively emanating towards the front of the headphones 200.

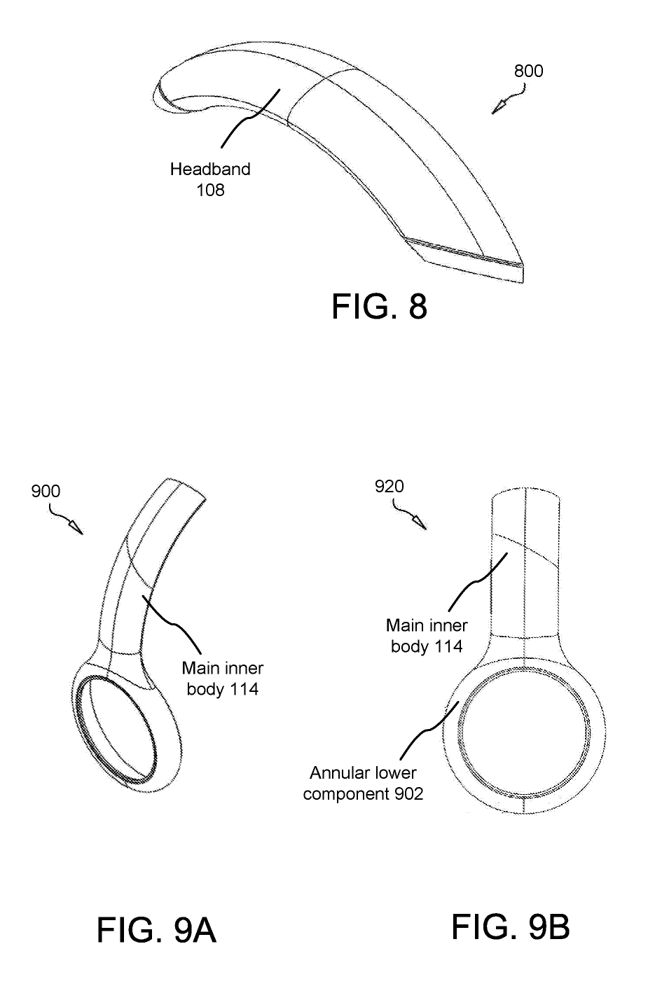

FIG. 8 is an elevated front-side perspective view of a headband 800 of interactive headphones with virtual controls and integrated memory in accordance with the present invention. The arcuate headband 108 is substantially described above.

FIGS. 9A-9B illustrate perspective views of a main inner body of interactive headphones with virtual controls and integrated memory in accordance with the present invention.

The main inner body 114, as shown, defines a hollow recess which traverses two open ends of the main inner body 114 for receiving the touch display 202. The open ends are on the exterior outer surface and the interior surface. The main inner body 114 may comprise an integrated annular lower component 902.

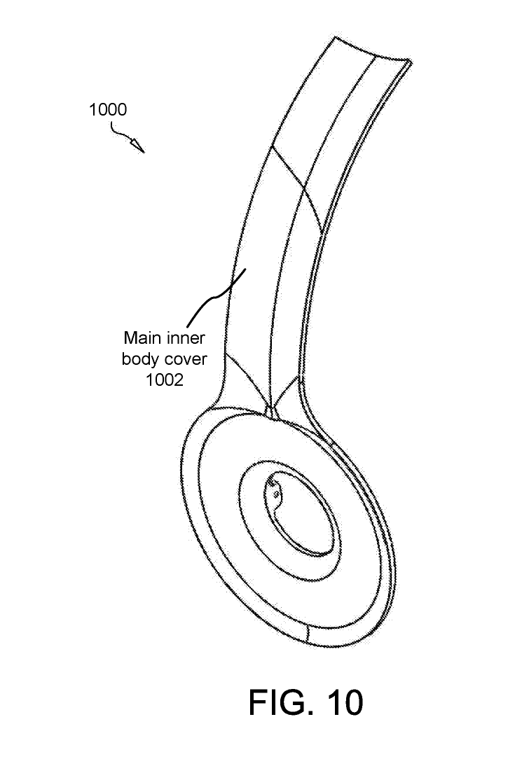

FIG. 10 is a front-side perspective view of a main inner body cover 1000 of interactive headphones with virtual controls and integrated memory in accordance with the present invention.

When the main inner body cover 1002 is joined with, or mated with, the main inner body 902, a recess or formed for receiving the touch display 202.

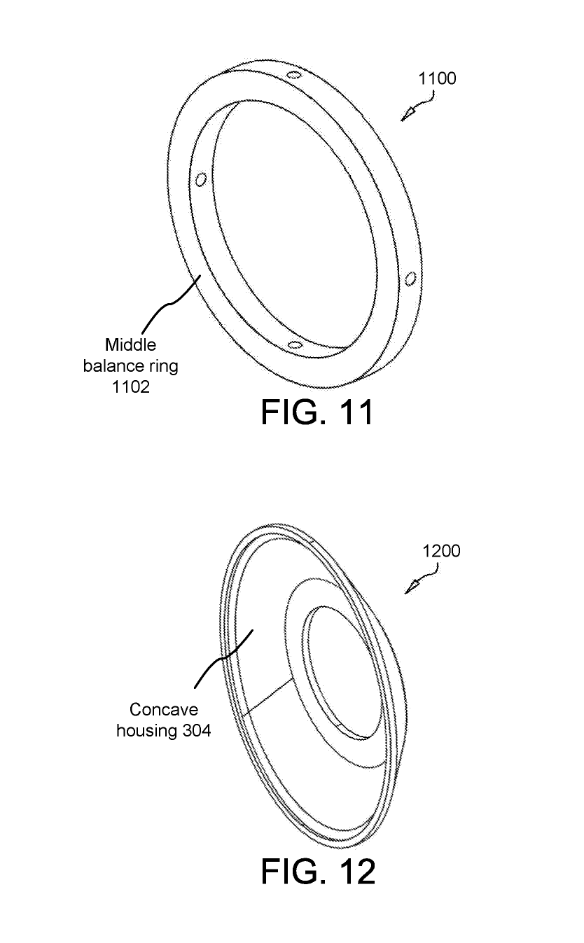

FIG. 11 is a front-side perspective view of a middle balance ring of interactive headphones with virtual controls and integrated memory in accordance with the present invention. FIG. 12 is a front-side perspective view of a concave housing of interactive headphones with virtual controls and integrated memory in accordance with the present invention.

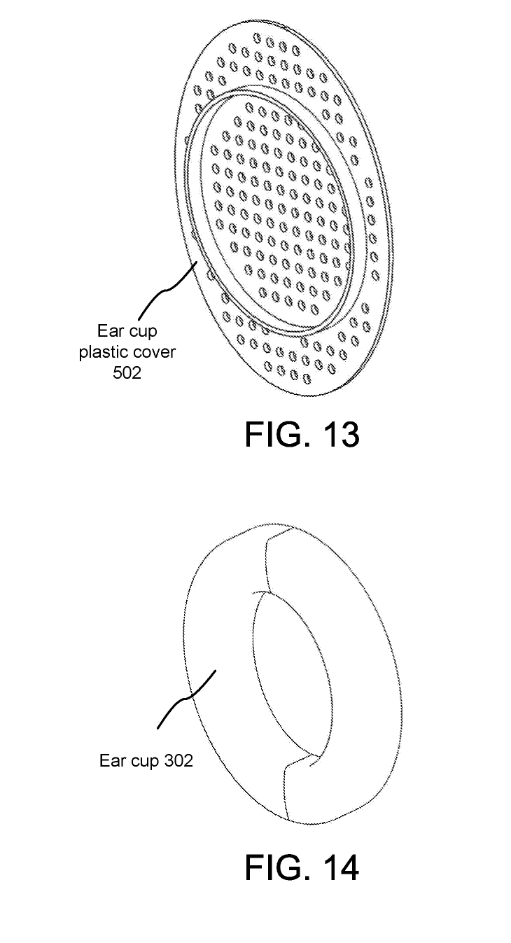

FIG. 13 is a front-side perspective view of an ear cup plastic cover of interactive headphones with virtual controls and integrated memory in accordance with the present invention. FIG. 14 is a front-side perspective view of an ear cup of interactive headphones with virtual controls and integrated memory in accordance with the present invention. FIGS. 11-14 as shown. The ear cup 302 is substantially described above.

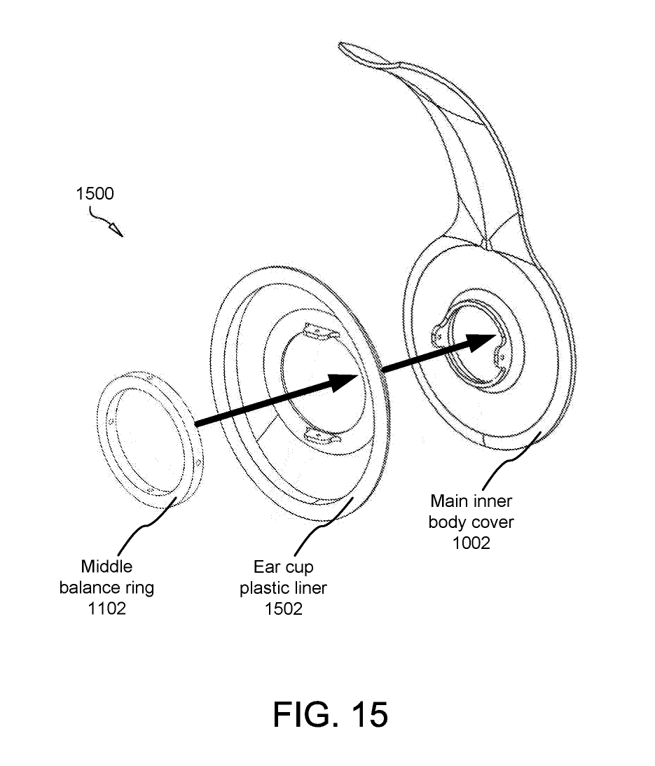

FIG. 15 is a front-side perspective view of a subassembly of interactive headphones with virtual controls and integrated memory in accordance with the present invention.

The earpiece 110 is formed by the mating and combination of inter alia the main inner body cover 1002, the ear cup plastic liner 1502, and the middle balance ring 1102.

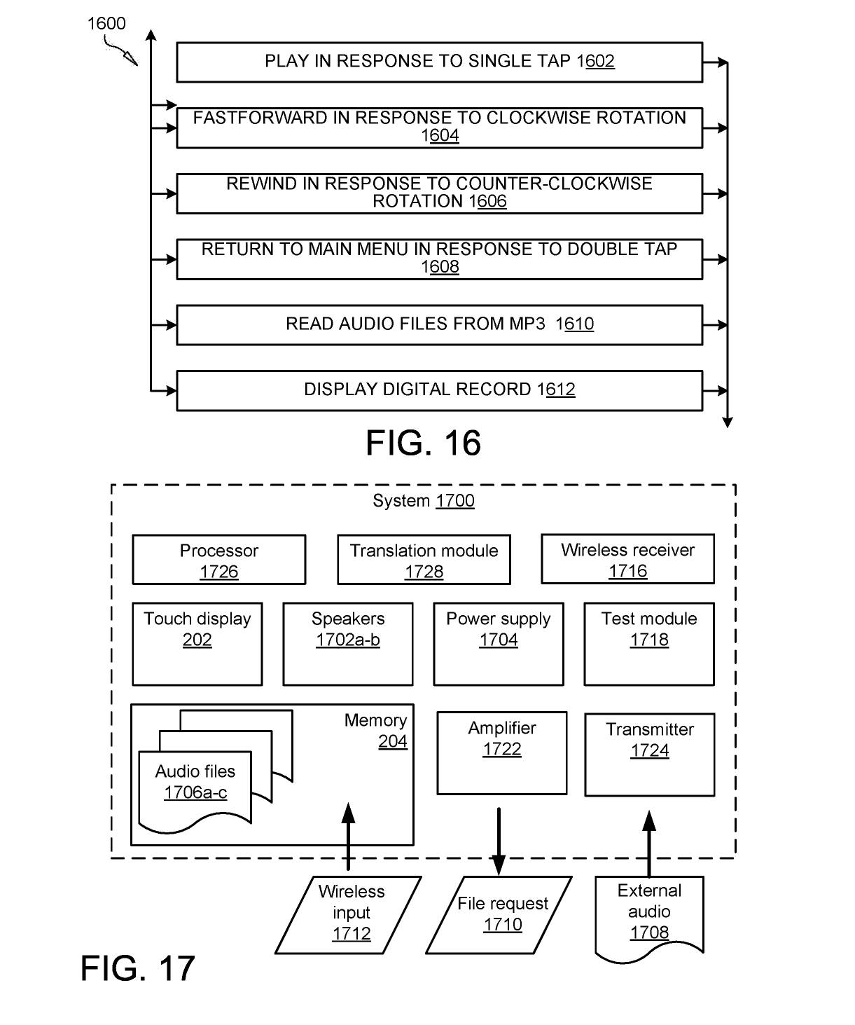

FIG. 16 is a flow chart of the steps of a method 1600 for controlling interactive headphones with virtual controls and integrated memory in accordance with the present invention.

The method begins 1602 when an audio file in memory 204 is played 1602 via the headphone 200 is response to a wearer engaging the touch display 202 with a single tap.

The audio file is fastforwarded 1604 in playback mode in response to a wearer engaging the touch display 202 with a finger in clockwise rotational movement.

The audio file is rewound 1606 in playback mode in response to a wearer engaging the touch display 202 with a finger in counter-clockwise rotational movement.

The operating system of the headphones 200 reverts or returns 1608 to a main menu in response to a wearer engaging the touch display 202 with two fingers simultaneously.

Audio files are read 1610 from memory 204, and media in memory 204 may be display 1612 on the touch display 202.

FIG. 17 is a block diagram of the modules of a system 1700 for controlling interactive headphones with virtual controls and integrated memory in accordance with the present invention. The system 1700 comprises a processor 1726, a wireless receiver 1716, a touch display 202, speakers 1702a-b, a power supply 1704, a wireless reciver 1716, an advancer module 1718, a memory 204 comprising a plurality of audio files 1706a-c, an amplifier 1722, and a transmitter 1724.

In various embodiments, wireless input 1712 is received by the system 1700 via the receiver 1716 using protocols and means known to those of skill in the art, including BlueTooth®. This wireless input 1712 may be sent from a remote data processing device (DPD) such as a tablet computer, smart phone, server, personal computer, and the like. In various embodiments, the remote DPD is in wireless connectivity with the system 1700 via a local area network (LAN) or wide area network (WAN).

External audio files 1708 may be transmitted to the system 1700, and the system 1700 may alternatively be adapted to transmit file requests 1710 to a remote DPD.

In various embodiments, the system 1700 comprises a translation module 1728 configured to take an audio signal input from the microphone and recognize a spoken language, then translate this spoken language and play the translation via the speakers.

The system 1700 may comprise a test module 1718 configured to play tones of increasing frequencies and decibels via speakers forming part of the system 1700. The test module 1718 prompts the wearer to confirm the wearer has heard the sound via the touch display 202 by displaying an virtual acknowledgement button on the display 202.

The test module 1718 serves to provide a hearing test to wearers of the headphones 200 or system 1700. Wearers may configure the system 1700 to play only predetermined tones of specific frequencies and decibels using virtual setting controls on the display 202.

The test module 1718 may also be configured to limit audio output by the speakers to 85 decibels or less to protect a wearer's hearing. This 85 decibel level constitutes the predetermined volume threshold; however, the predetermined volume threshold may also be set by a wearer using virtual controls on the touch display 202.

In various embodiments, the sytem 1700 is configured to transmit a digital copy of the audio file 1706 in playback wirelessly to another pair of headphones 200 on a LAN or WAN. In this manner, a plurality of headphones connected on a LAN may simultaneously receive a digital audio signal, which may comprise music, sport commentary, news, or real-time updates.

Using the wireless functionality of the system 1700, a system 1700a may relay an audio signal to a system 1700b, which may in turn relay the same audio signal to a system 1700c, and so on, resulting in a plurality of wearers all hearing the same audio input simultaneously. The system 1700 may, in this manner, also act as a relay station for wireless signals in large crowds from an initiating source.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. Interactive headphones for storing computer-readable audio files and generating sound therefrom, the headphones comprising:
an arcuate headband adapted for contouring a wearer's head, the arcuate headband defining two hollow recesses for receiving a male end of an inner body;
two inner bodies affixed to the arcuate headband, each of the inner bodies adapted to slide longitudinally within a hollow recess;
a circular touch screen recessed into an exterior outer surface of one of the inner bodies;
a battery;
an amplifier;
a control module comprising a processor, the control module configured to display virtual controls in the form of a virtual image of a record on the touch display, the virtual manipulable to start, stop, fastforward and rewind playback of an audio file in computer readable memory;
computer readable memory; and
two earpieces affixed to an inner body for engaging the ear of the wearer, the earpieces comprising:
a concave ear cup with an open inner end defining a first hollow recess for receiving a speaker;
a speaker; and
a detachable flexible ear cup for annularly circumscribing the ear cup.

2. The headphones of claim 1, further comprising a plurality of depressible buttons for raising and lower a volume of sound emanating from the speakers.

3. The headphones of claim 1, wherein the control module is configurable by a user to set a maximum volume decibel level for each respective speaker, the maxium volume deciblel level stored in the computer readable memory.

4. The headphones of claim 3, wherein the control module limits sounds emiting from each speaker to a volume less than the maxium volume decibel level exclusively associated with said speaker.

5. The headphones of claim 1, wherein the control module is configurable by a user to set a playback percentage for each speaker, the playback percentage exclusively associated with a speaker, the playback percentage stored in the computer-readable memory.

6. The headphones of claim 5, wherein the control module emits a percentage of volume corresponding to the playback percentage through a speaker exclusively associated with the playback percentage.

7. The headphones of claim 1, wherein the touch screen is 2.5 inches in diameter.

8. The headphones of claim 1, further comprising a depressible power button disposed beneath the touch screen. H 9. The headphones of claim 1, wherein the touch screen is adapted to fast forward playback of an audio file in computer-readable memory in response to sensing a wearer's engagement of the touch screen with a finger in a clockwise direction.

10. The headphones of claim 9, wherein the touch screen is adapted to rewind playback of an audio file in computer-readable memory in response to sensing a wearer's engagement of the touch screen with a finger in a counterclockwise direction.

11. The headphones of claim 10, wherein the touch screen is adapted to stop forward playback of an audio file in computer-readable memory in response to sensing a wearer's taping the touch screen with a finger.

12. The headphones of claim 11, wherein the touch screen is adapted to return to a main menu in response to sensing a wearer's taping the touch screen with two fingers.

13. The headphones of claim 12, wherein the touch screen is adapted to return to a main menu in response to sensing a wearer's taping the touch screen with two fingers.

14. The headphones of claim 1, further comprising a wireless receiver, the headphones adapted to receive wireless input via the wireless receiver transmitted from a tablet computer, the wireless input changing playback settings on the headphones.

15. The headphones of claim 14, wherein the headphones are in wireless connectivity with the tablet computer using BlueTooth® technology.

16. The headphones of claim 14, wherein an output of the speakers is limited to 85 decibels.

17. The headphones of claim 1, wherein the touch screen is configured by the wearer to display a logo of an athletic team.

18. The headphones of claim 1, wherein an audio file being played back on the headphones is transmitted wireless to a second pair of headphones inconnected with the headphones via a LAN.

19. The headphones of claim 1, further comprising a forward facing camera.

20. Interactive headphones for storing computer-readable audio files and generating sound therefrom, the headphones comprising:
an arcuate headband adapted for contouring a wearer's head, the arcuate headband defining two hollow recesses for receiving a male end of an inner body;
two inner bodies affixed to the arcuate headband, each of the inner bodies adapted to slide longitudinally within a hollow recess;
a circular touch screen recessed into an exterior outer surface of one of the inner bodies, the circular touch screen 2.5 inches in diameter;
a battery;
a computer-readable memory;
a computer program product operable to impart function to the headphones, the computer program product operable to display virtual controls in the form of a virtual image of a record on the touch display, the virtual manipulable to start, stop, fastforward and rewind playback of an audio file in computer readable memory;
computer readable memory; and
two detachable earpieces affixed to an inner body for engaging the ear of the wearer, the earpieces comprising:
a concave ear cup with an open inner end defining a first hollow recess for receiving a speaker;
a speaker; and
a detachable flexible ear cup for annularly circumscribing the ear cup.
